(19) United States
(12) Patent Application Publication
(10) Pub. No.: US 2008/0082419 A1
(43) Pub. Date: Apr. 3, 2008

(54) Internet Search and Action Incentivization System and Associated Methods

(75) Inventor: Randy Joseph Randall, Orlando, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: WEBGNE.COM, LLC, Maitland, FL (US)

(21) Appl. No.: 11/866,533

(22) Filed: Oct. 3, 2007

Related U.S. Application Data
(60) Provisional application No. 60/848,944, filed on Oct. 3, 2006.

(51) Int. Cl. G06Q 30/00; G06F 17/30; G06F 17/40

(52) U.S. Cl. 705/14

(57) ABSTRACT

An Internet search provider and incentive system includes a database and a processor. The database contains user account data, data relating to items available, and a rule set for obtaining the items. A software system can receive a selection for a search to be performed and interface with an Internet search engine. The Internet search engine can perform the user-selected search and increment a user account by a reward unit. The search results are displayed, and also an available reward. Available purchase options are displayed for obtaining an item based upon the associated rule set. A first option is based upon a reward unit total in the user account; a second option, upon a monetary total; and a third option, upon a combination of reward units and a monetary amount. A user selection can be received relating to the item to obtain and relating to a purchase option.

### CROSS-REFERENCE TO RELATED APPLICATION

This application claims priority to U.S. Provisional Application Ser. No. 60/848,944, filed Oct. 3, 2006.

### FIELD OF THE INVENTION

The present invention relates to a system and method of conducting a search or performing another type of action on the Internet, and, more particularly, to a system and method for conducting a search or action in which a reward is awarded to a user.

### BACKGROUND OF THE INVENTION

A primary source of revenue for search providers on the Internet is money generated from paid advertisements, leading to the rapid growth of some search providers, including Google and Yahoo. Consequently, strategies to further increase income to search providers have been formulated. An original strategy for income generation was the pay-per-impression strategy, wherein an advertiser pays whenever a listing is displayed. However, this strategy led to conflicts among advertisers who sought preferable positions in a search listing in order that traffic be directed to their web sites.

Another strategy comprises bidding on keywords associated with one or more advertisers, so that those advertisers' websites were preferentially identified in search results. Variations of the keyword search strategy have been used by all known search engine providers.

A more recent strategy is the use of paid advertisements that are displayed along with search engine results, which is commonly referred to as pay-per-click or pay-for-performance advertising. In this scheme, an advertiser bids on a popular search term in exchange for prominent placement of its advertisement. Typically, more than one advertiser bids on more popular search terms, so that the listings are placed based upon the amount bid and the performance of the listing as measured by the number of users who use the listing. Those listings with the highest bids and the best performance are given the most prominence. This scheme has several drawbacks. For example, low-performing listings generate little revenue and will not be given prominent placement no matter how much the advertiser has bid for a position because there is no revenue for the search provider. Still another limitation is that the requirement for a minimum bid may eliminate smaller users from taking advantage of the system

It would thus be advantageous to create a pull-through form of advertising that brings additional revenue to the search provider based upon demand from search engine users for advertised items.

### SUMMARY OF THE INVENTION

The present invention is directed to a system that creates advertising revenue for a search engine provider based upon a pull-through marketing technique and that provides users with an incentive to use the search engine. This incentive can comprise a rebate of a fractional portion of the advertising paid to the search engine provider that accrues to a user in the form of points, which in the specific embodiment of the present software system are referred to as search points, or “miles,” in analogy to frequent flier miles.

In particular, an Internet search provider and user incentive system is provided that comprises a processor accessible by a user over the Internet and a database in signal communication with the processor. The database contains user account data, data relating to a plurality of items available to the user, and a rule set for obtaining each of the items.

A software system is resident on the processor that comprises code segments adapted to receive a user selection for a search to be performed on the Internet and interface with an Internet search engine. Code segments are further provided that can direct the Internet search engine to perform the user-selected search and increment a user account by a reward unit. The results obtained by the search engine are displayed to the user, and also a reward available to the user. A plurality of purchase options available to the user are further displayed, the purchase options for obtaining an item based upon the associated rule set. A first option is based upon a reward unit total in the user account; a second option is based upon a monetary total; and a third option is based upon a combination of reward units and a monetary amount. A user selection can be received relating to the item to obtain and relating to a purchase option.

The reward units, or points, that are awarded to the user can be based upon a number of factors, including, but not intended to be limited to, the revenue provided to the search provider from the advertiser, whether the advertiser subsidizes the points as a loss leader in an effort to attract users to its website and to make purchases there, whether the user when making a purchase chooses to pay for the transaction in dollars or points, a scheme associated with the margin of product, and the number of searches the user makes.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a diagram of the relationship of a plurality of modules to the main search module.

FIG. 2 is a flow diagram of the system for incrementing search points and displaying the user's total number of points.

FIG. 3 is a diagram of the business scheme for determining the worth of a search point.

FIG. 4 is a flow diagram of how search points are awarded in a web keyword search module.

FIG. 5 is a flow diagram of how items are purchased and search points are redeemed through a redemption center zone.

FIG. 6 is a flow diagram of how search points are awarded in a classifieds zone.

FIG. 7 is a flow diagram of how search points are awarded in a blog zone.

FIG. 8 is a flow diagram of how search points are awarded in a video zone.

FIG. 9 is a flow diagram of how search points are awarded in a travel zone.

FIG. 10 is a flow diagram of how search points are awarded in a social zone.

FIG. 11 is a flow diagram of how search points are awarded in an auction zone.

FIG. 12 is a flow diagram of how search points are awarded in an email module.

FIG. 13 is an exemplary page for displaying selections of “popular shortcuts” for searching.

FIG. 14 is an exemplary page for displaying results of a selection of a travel shortcut.

FIGS. 15 and 16 is an exemplary page for displaying results of a user-defined search.

FIG. 17 is an exemplary page for displaying exchange rates for reward units.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

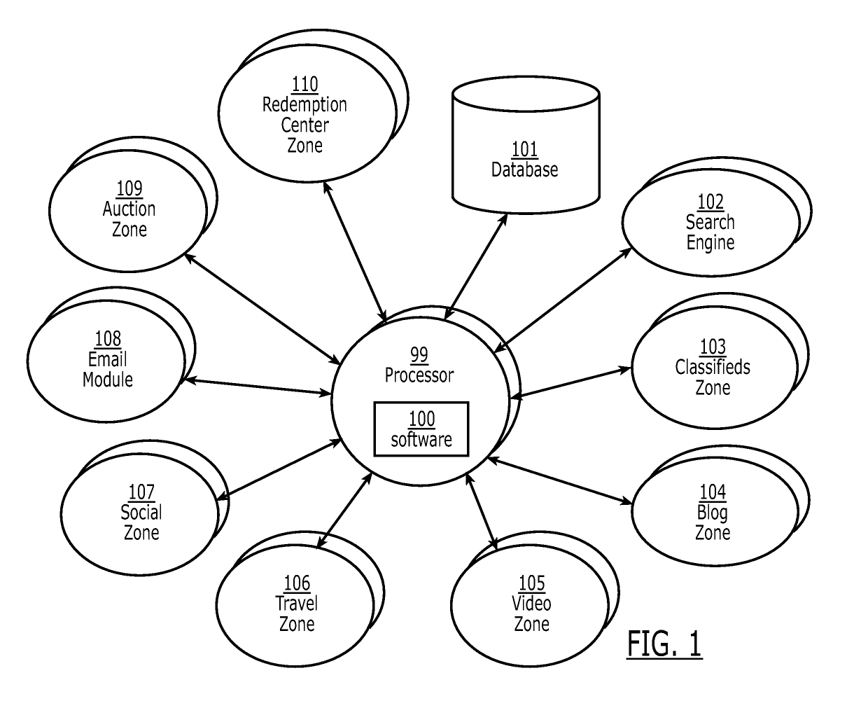

An Internet search system 100 (FIG. 1), which can reside on a server/processor 99, for example, can include a plurality of zones/modules that permit a user to obtain search points for each of a plurality of available actions. The search engine provider can award the user with a number of search points if actions are taken that result or that may result in the search engine provider's earning revenue from a commercial link. As used herein, an action can comprise a search, accessing a hyperlink, an upload or download of information, or other activity that a user might take when accessing an Internet search engine on which the search system 100 resides. Each specific action can be associated with a number of points that can be provided to a user when the specific action is performed.

The processor 99 on which software system 100 resides is in signal communication with a database 101 that allows a user to perform at least one of a variety of actions by accessing at least one of a plurality of modules, or “zones,” which can include, for example, a search engine 102; a classifieds zone 103; a blog zone 104; a video zone 105; a travel zone 106; a social zone 107; an email module 108; and an auction zone 109. In addition, the software system 100 can include a search points redemption center 110 that functions in similar fashion to a retail purchase website, allowing the user to redeem search points alone or in combination with a monetary purchase for goods or services.

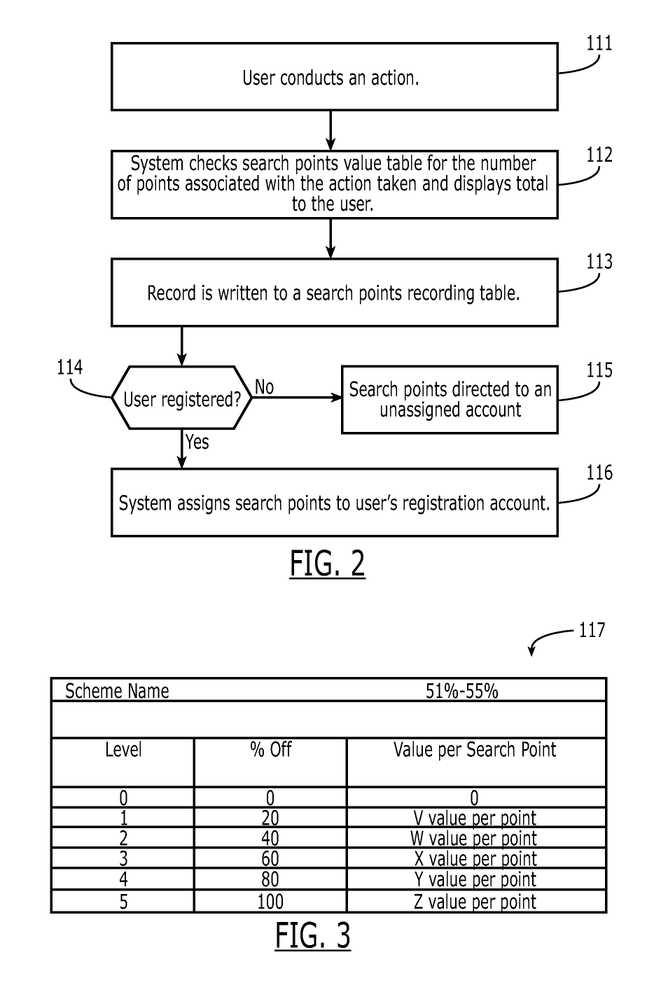

Any time a user conducts a search, accesses a zone, or performs any other action for which the system has assigned a search point value will hereinafter be referred to as an action (FIG. 2; block 111). In at least some of the plurality of modules 102-109 in the system 100, there exists a search point data table associated with the particular action taken (block 112). Upon the user's conducting an action, the system 100 determines the search points associated with the action, displays the user's total points accumulated, and records the value in a search points recording table (block 113). The system 100 then inquires whether the user is registered (block 114). If not, the system 100 assigns the search points to an unassigned account (block 115). If the user is registered, the system 100 assigns the appropriate number of search points depending upon the action taken to the user's registration account (block 116).

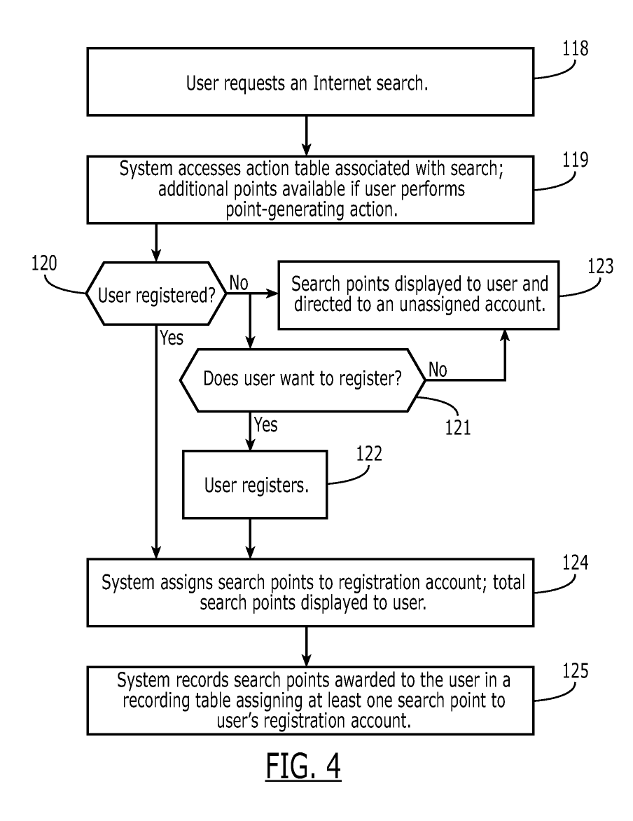

Until such time as the search points are redeemed, they have no monetary value. An exemplary search point value scheme 117 for assigning a dollar value to search points is illustrated in FIG. 3. The monetary value of a search point is a variable based upon a number of factors, which can include the manufacturer's suggested retail price of the item to be purchased, the wholesale cost of the item, its list price, and its outlet center price. The scheme name, shown in FIG. 3 as “51%-55%,” is indicative of the margin available to the retailer, which in this instance is a search engine provider. Generally, the greater the margin available to the retailer for the sale of an item, the higher the search point value associated with the item. As shown in the table 117, the system 100 further includes a discounted purchase system, which permits a user to purchase the item entirely with dollars, entirely with search points, or with some combination of the two. The system 100 also has a sliding scale of search point values, so that when a user purchases an item entirely with search points having value Z, those search points are worth less in dollar value than if the user had purchased the same item with a product with search points to obtain a twenty percent discount, valued at V dollars, for example. This provides the user with an incentive to purchase the item with money, using the search points to obtain a discount rather than making a complete purchase with search points.

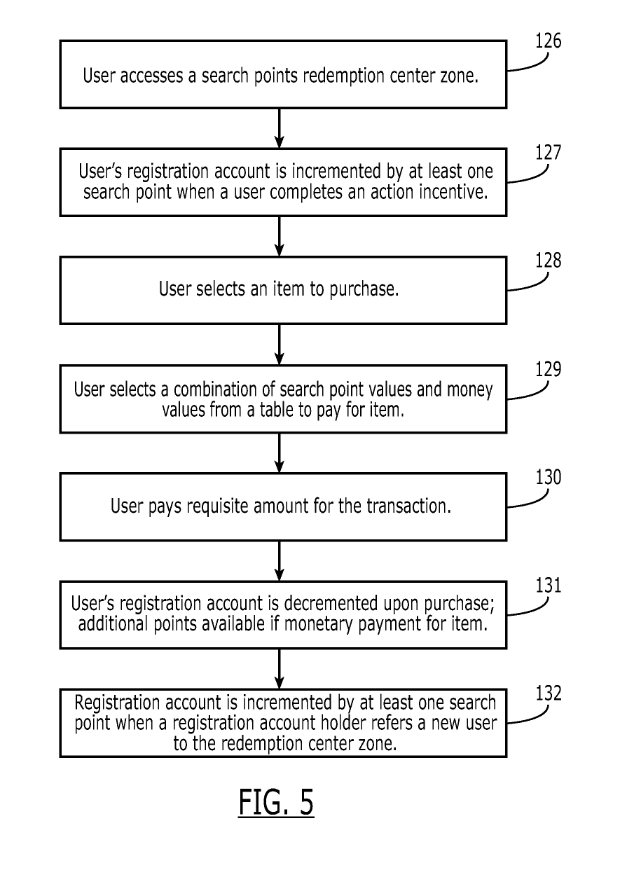

The search engine 102 allows the user to perform a keyword web search using a number of pre-existing search engine providers (FIG. 4; block 118), such as Google, for example, as well as its own system. Upon entering a search, the system 100 accesses an action table associated with the search engine module 102 to determine the number of search points, if any, that may be awarded to the user (block 119). Points can also be earned by performing additional actions, such as, but not intended to be limited to, taking a survey offered by the system 100 or purchasing an item or service offered through the system 100.

The system 100 then inquires whether the user is registered (block 120). If not, the user is permitted to conduct the search, but any search points awarded are directed to an unassigned account (block 120). In such case, the user is asked if he/she wishes to register (block 121). This request to register may occur immediately, or may occur somewhat later, for example, after the user has accrued a certain number of search points. If so, the system 100 then brings up a registration screen, and the user can register (block 122). If not, the search points remain unassigned (block 123). Once registered, the search points are awarded to a registration account that is maintained on the system 100 (block 124). The system 100 then increments a recording table that is associated with the user's registration account (block 125).

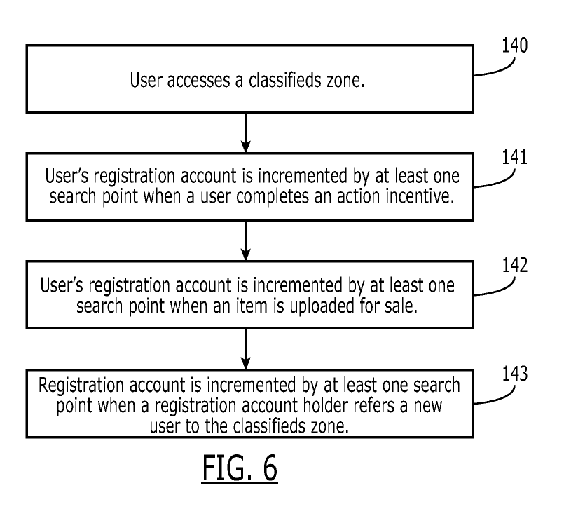

The search points redemption center 110 is in communication with a database 101 having a selection of items a user may purchase (FIG. 5). A user can access the search point redemption center zone 110 by selecting a link on a system homepage or by direct access (block 126). If the user completes any actions before proceeding with a purchase, at least one search point per action can be awarded (block 127). The user then selects an item for purchase (block 128). A search point value table 117 associated with the particular product selected appears and offers the user a choice of a combination of search points and money associated with the selected item (block 129). As previously shown, the user then selects the option of all dollars or a twenty percent discount on the price of the item. The user can use a credit card or other form of currency to purchase an item (block 130). The search points have a value identified in the table 117 of search point values associated with the item decremented from the registration account upon purchase (block 131). Points may also accrue if the user spends at least some money in addition to points for the item. Also, the user's registration account is incremented by at least one search point if the user refers a new user to the redemption center zone 100 (block 132).

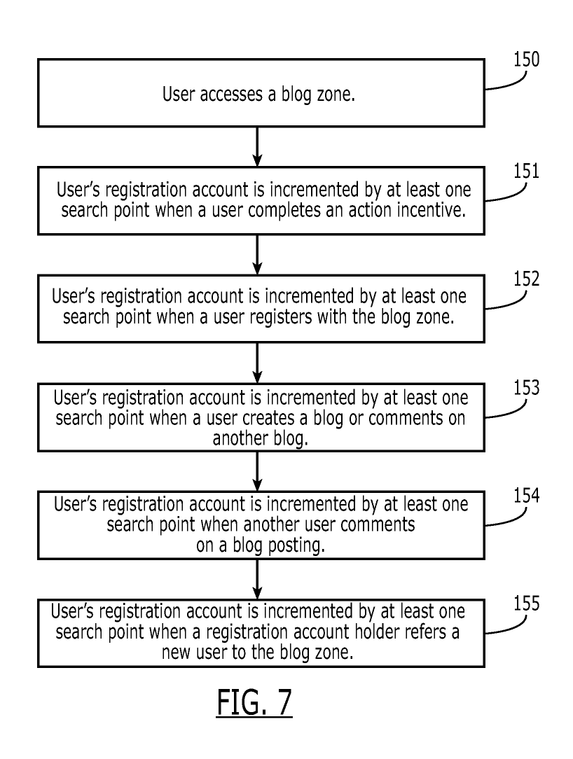

The system 100 further includes a classifieds zone 103. When a user accesses the classifieds zone 103 or completes another action incentive (FIG. 6; block 140), the registration account is incremented by at least one search point (block 141), and also when an item is uploaded for sale (block 142). The registration account is also incremented by at least one search point when a registration account holder refers a new user to the classifieds zone (block 143).

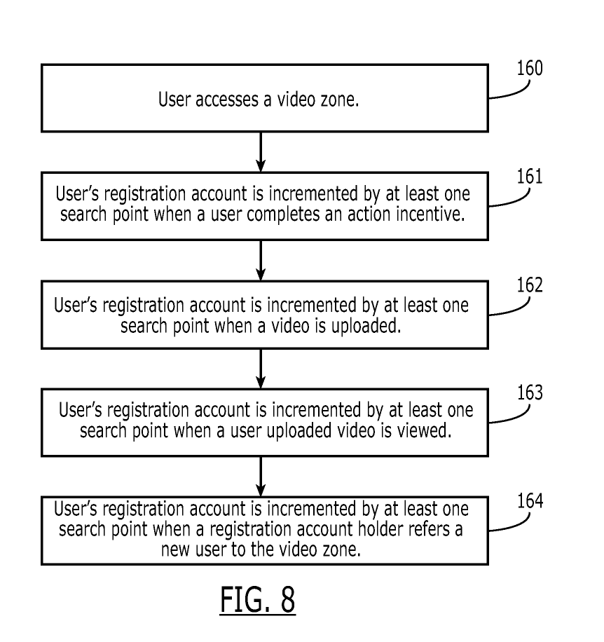

If a user accesses a zone for posting user-created material, or, a “blog” zone 104 (FIG. 7; block 150), the registration account is incremented by at least one search point (block 151). When a user registers with the blog zone 104 (block 152), the registration account is incremented by at least one search point, and also when a user posts a blog or comments on another user's blog (block 153). The registration account is further incremented by at least one search point when a user comments on a blog posting (block 154), and also when a registration account holder refers a new user to the blog zone (block 155).

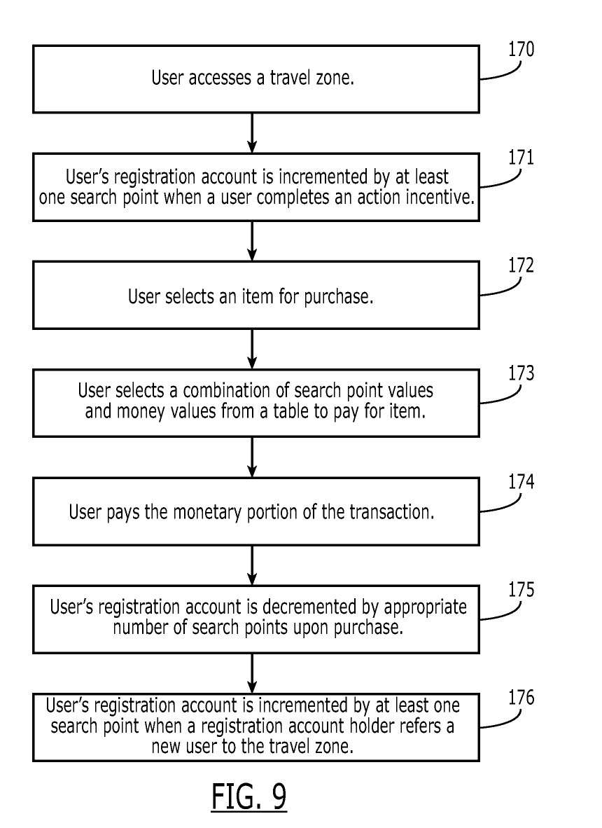

When a user accesses a video zone 105 (FIG. 8; block 160), the registration account is incremented by at least one search point (block 161), and also when a user uploads a video (block 162). The registration account is further incremented by at least one search point when a user-uploaded video is viewed (block 163), and further by at least one search point when a registration account holder refers a new user to the video zone (block 164).

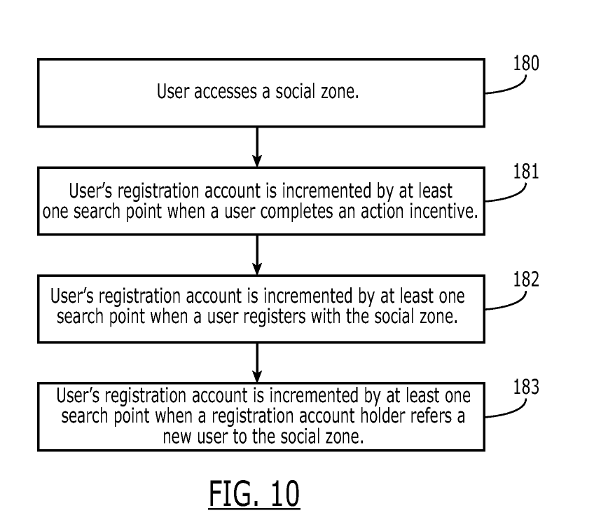

When a user accesses a travel zone 106 (FIG. 9; block 170), the registration account is incremented by at least one search point (block 171). The user can select (block 172) and purchase an item with a combination of search points and money according to defined schemes relationally associated with the selected item (block 173). In some embodiments, travel items may not be available for redemption solely using search points, but such items may be available at deeply discounted monetary values. The user pays the monetary portion (block 174), and the requisite search point values are decremented from the user's registration account (block 175). Again, the registration account is incremented by at least one search point when the account holder/user refers a new user to the travel zone (block 176).

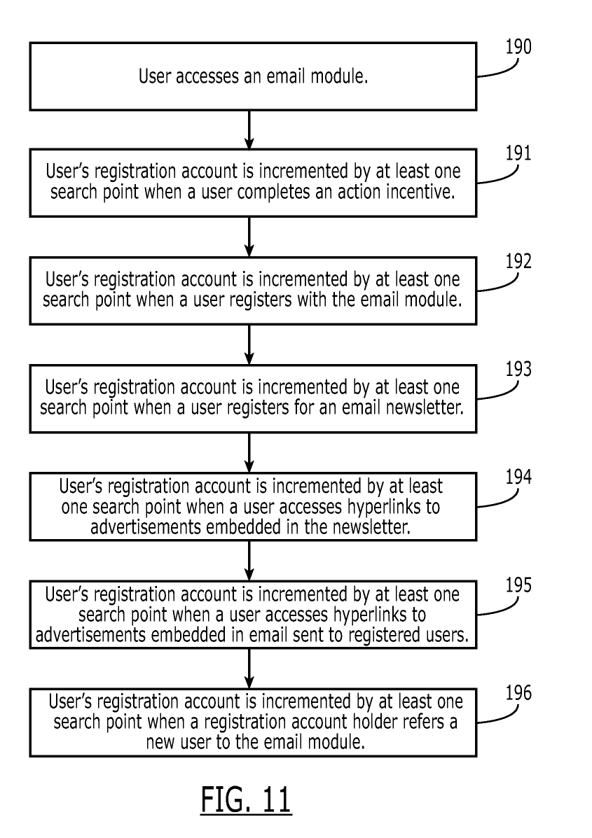

When a user accesses a social zone 107 (FIG. 10; block 180), the registration account is incremented by at least one search point (block 181), and also when the user registers with the social zone (block 182). The registration account is incremented by at least one search point when a registration account holder refers a new user to the social zone (block 183).

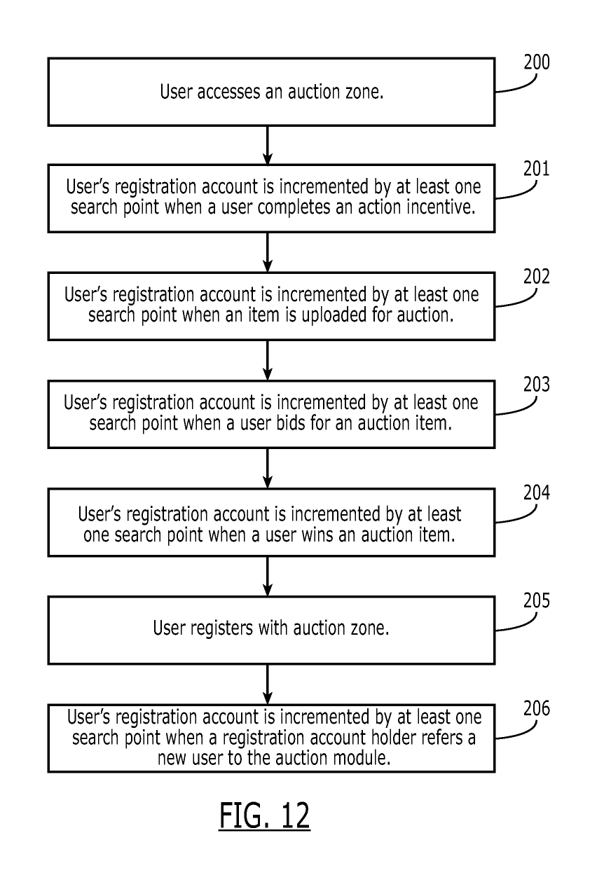

When a user accesses an email module 108 (FIG. 11; block 190), the registration account is incremented by at least one search point (block 191), and also when the user registers for the module 108 (block 192) and for a newsletter having additional links to add search points (block 193). The registration account is incremented by at least one search point when the user accesses a hyperlink in the newsletter (block 194), or in a system email including an opportunity to obtain additional search points (block 195). The registration account is incremented by at least one search point when an account holder refers a new user to the email module (block 196).

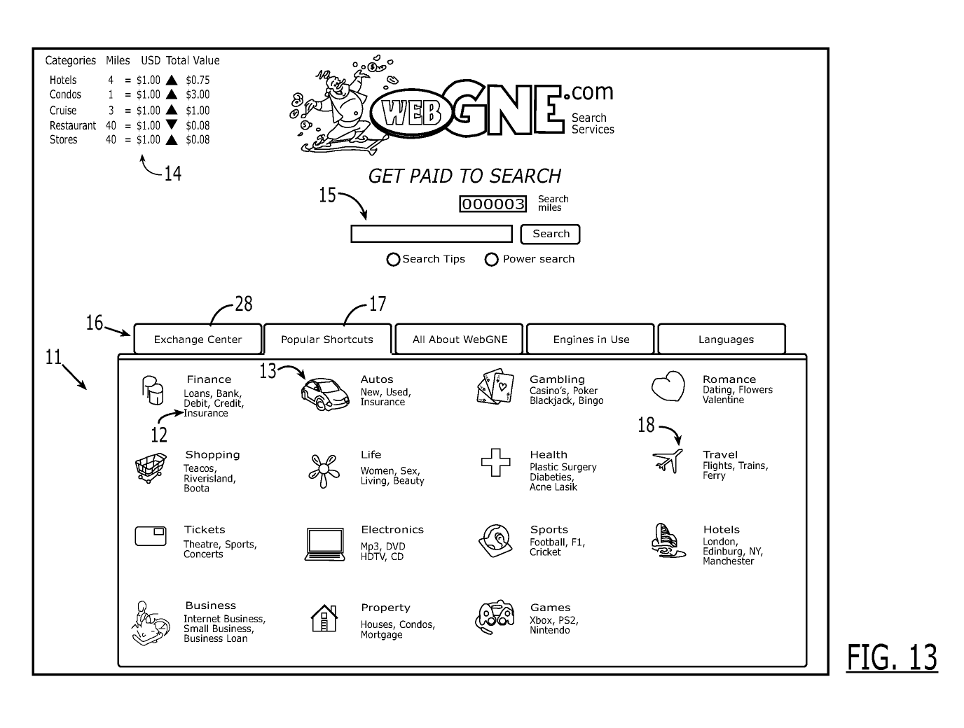

When a user accesses an auction zone 109 (FIG. 12; block 200), the registration account is incremented by at least one search point (block 201). At least one search point can also be earned by uploading an item for auction (block 202), when a user bids on an auction item (block 203), and when a user wins an auction (block 204) The registration account is incremented by at least one search point when a user registers with the auction zone 109 (block 205), and when an account holder refers a new user to the auction zone (block 206).

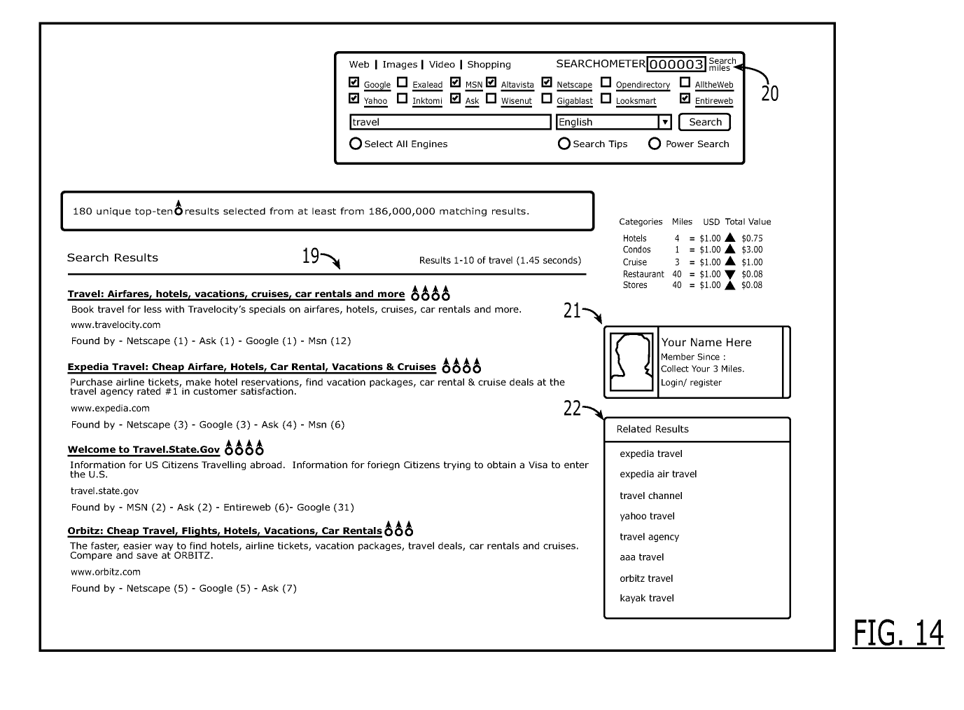

A set of exemplary web pages are illustrated in FIGS. 13-17. It will be understood by one of skill in the art that the exact configuration and connectivity of these pages are not intended to form a limitation on the invention, and that the look and feel of the pages may be altered without departing from the spirit of the invention. Therefore, these pages are provided merely as being illustrative in nature, to indicate some of the features of the invention.

In a page (FIG. 13) for displaying “popular shortcuts” 11 are presented a plurality of generic categories, such as finance 12, autos 13, etc. This page shows an exemplary point chart 14, a search box 15, and a plurality of tabs 16, of which the “popular shortcuts” tab 17 is highlighted. Revenue is generated for the system administrator every time a user transitions to a sponsored site through this means. Also, if the user decides to make the system's home page his/her home page, additional points may accrue.

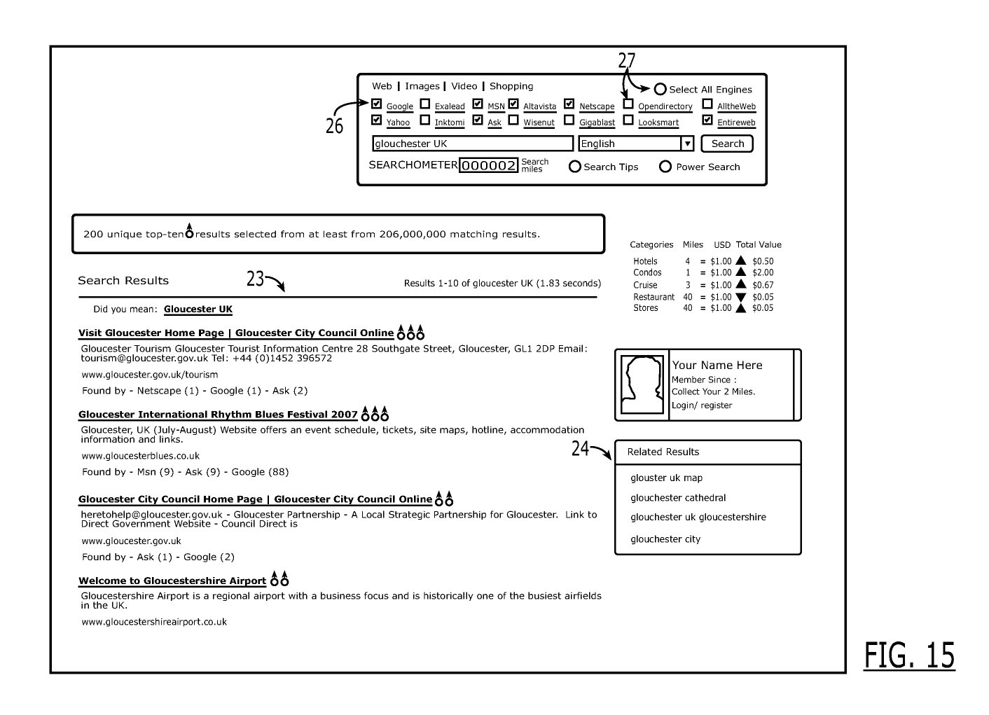

Selecting one of the shortcuts 11, here, travel 18, brings up a screen (FIG. 14) with a list of hyperlinks 19 to travel-related sites. This screen also displays the user's current search point total 20, along with a box 21 relating to the user. A box 22 of related results is also displayed.

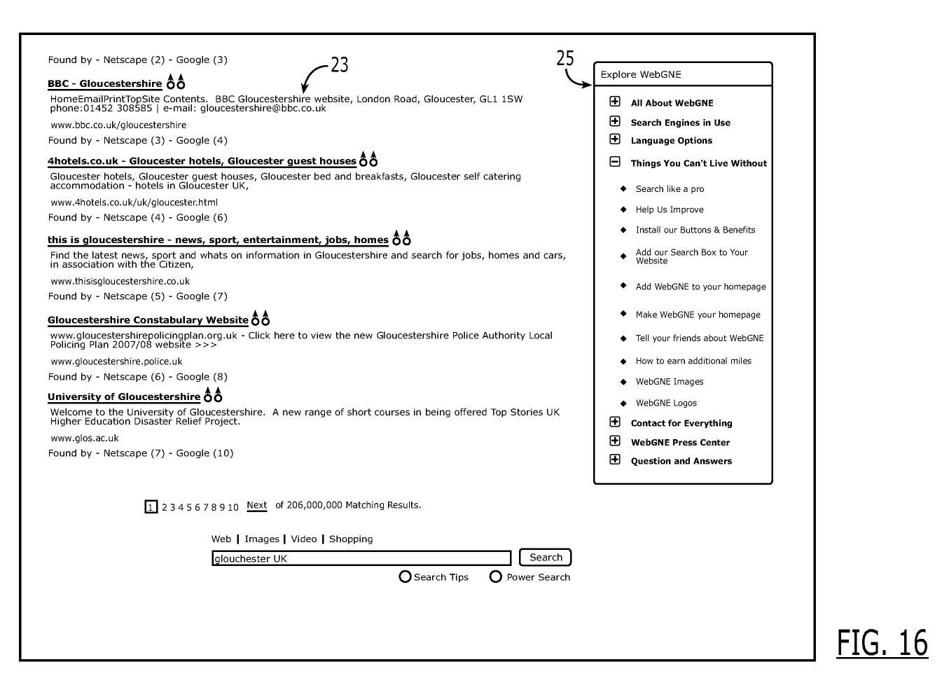

If the user elects to enter his/her own search term(s) in the search box 15, screens such as illustrated in FIGS. 15 and 16 appear, again providing hyperlinks 23 to websites located in the search and related results 24. A list of informational hyperlinks 25 is also brought up (FIG. 16) relating to the system 100 itself.

In a particular embodiment, the system 100 is adapted to direct a user's search through one or more extant search engines 26, which are user-selectable 27 if desired, and which can be entered via their respective hyperlinks.

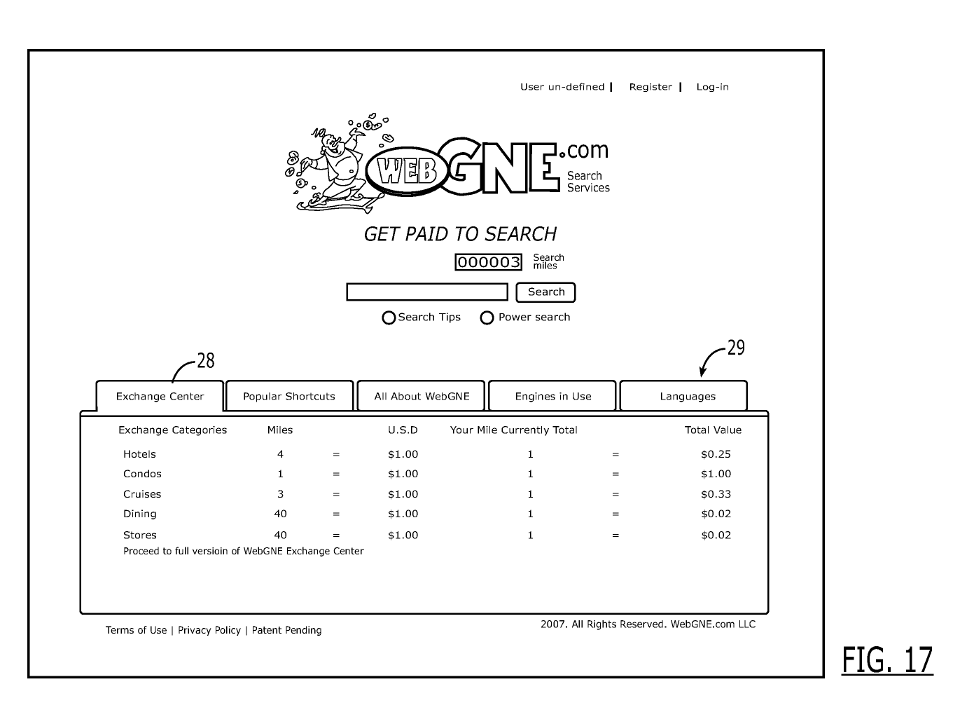

If the “exchange center” tab 28 is selected, a table 29 of exchange categories, “miles,” dollar equivalents, current total miles, and total monetary value is displayed for the current user (FIG. 17). The user can trade in miles with or without combining the miles with a monetary portion.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An Internet search provider and user incentive system comprising:
a processor accessible by a user over the Internet;
a database in signal communication with the processor, the database containing data relating to a user account, data relating to a plurality of items available to the user, and a rule set for obtaining each of the items;
software resident on the processor, the software system comprising code segments adapted to:
receive a user selection for a search to be performed on the Internet;
interface with an Internet search engine;
direct the Internet search engine to perform the user-selected search;
increment the user account by a reward unit;
display results obtained by the search engine to the user;
display a reward available to the user;
display a plurality of purchase options available to the user for obtaining an item based upon the associated rule set, a first option based upon a reward unit total in the user account, a second option based upon a monetary total, and a third option based upon a combination of reward units and a monetary amount; and
receive a user selection of the item to obtain and of a purchase option.

2. The system recited in claim 1, wherein the software further comprises code segment adapted to, if the user-selected purchase option comprises one of the first option and the second option, decrementing the user account in the database with the reward units associated with the user-selected purchase option.

3. The system recited in claim 1, wherein the software further comprises code segments adapted to:
maintain a plurality of user-accessible modules, each module adapted to present the user with at least one available action, entry into each module by the user having a reward unit value associated therewith;
receive a user selection to enter one of the plurality of modules; and
increment the user account by the associated reward unit value.

4. The system recited in claim 3, wherein the software further comprises code segments adapted to:
receive a user selection to register in one of the plurality of modules; and
increment the user account with a reward unit following the user selection to register in one of the plurality of modules.

5. The system recited in claim 3, wherein the plurality of modules includes at least one of a site for the user to sell an item, a site for the user to enter an auction, a site for the user to send electronic mail, a site for posting user-created material, a site for uploading a user video, a site for the user to interact with other users, and a site for viewing travel-related information.

6. The system recited in claim 3, wherein the plurality of modules includes a site for posting user-created material, and wherein the software further comprises code segments adapted to:
receive a user selection to register in the site for posting user-created material;
increment the user account with a reward unit following the user registration in the site for posting user-created material;
receive a user selection to create a sub-site for posting user-created material;
increment the user account with a reward unit following the user creation of a sub-site;
receive a user selection to post a comment on a sub-site of another user; and
increment the user account with a reward unit following the user posting of a comment of another user sub-site.

7. The system recited in claim 3, wherein the plurality of modules includes a site for the user to send electronic mail, and wherein the software further comprises code segments adapted to:
receive a user selection to register in the site for sending electronic mail;
increment the user account with a reward unit following the user registration in the site for sending electronic mail;
receive a user selection to register for an electronic mail newsletter issued by the system;
increment the user account with a reward unit following the user registration to receive the electronic mail newsletter;
receive a user selection to link to an advertisement embedded in one of an electronic mail sent to the user via the electronic mail site and the electronic mail newsletter; and
increment a user account with a reward unit following the user linking to an advertisement embedded in the one of the electronic mail and the newsletter.

8. The system recited in claim 3, wherein the plurality of modules includes a site for the user enter an auction, and wherein the software further comprises code segments adapted to:
receive a user selection to register in the site for entering an auction;
increment the user account with a reward unit following the user registration in the site for entering an auction;
receive a user selection to upload an item onto the auction site;
increment the user account with a reward unit following the user uploading of the item for auction;
receive a user selection to bid on an item on the auction site;
increment the user account with a reward unit following the user bidding on the item on the auction site;
determine if the user wins an auction; and
increment the user account with a reward unit following the user winning the auction.

9. A method for providing an Internet search and a user with an incentive to perform a search, the method comprising the steps of:
establishing a database containing data relating to a user account, data relating to a plurality of items available to the user, and a rule set for obtaining each of the items;
receiving a user selection for a search to be performed on the Internet;
interfacing with an Internet search engine;
directing the Internet search engine to perform the user-selected search;
incrementing the user account by a reward unit;
displaying results obtained by the search engine to the user;
displaying a reward available to the user;
displaying a plurality of purchase options available to the user for obtaining an item based upon the associated rule set, a first option based upon a reward unit total in the user account, a second option based upon a monetary total, and a third option based upon a combination of reward units and a monetary amount; and
receiving a user selection of the item to obtain and of a purchase option.

10. The method recited in claim 9, further comprising the step of, if the user-selected purchase option comprises one of the first option and the second option, decrementing the user account in the database with the reward units associated with the user-selected purchase option.

11. The method recited in claim 9, further comprising the steps of:
maintaining a plurality of user-accessible modules, each module adapted to present the user with at least one available action, entry into each module by the user having a reward unit value associated therewith;
receiving a user selection to enter one of the plurality of modules; and
incrementing the user account by the associated reward unit value.

12. The method recited in claim 11, further comprising the steps of:
receiving a user selection to register in one of the plurality of modules; and
incrementing the user account with a reward unit following the user selection to register in one of the plurality of modules.

13. The method recited in claim 11, wherein the plurality of modules includes at least one of a site for the user to sell an item, a site for the user to enter an auction, a site for the user to send electronic mail, a site for posting user-created material, a site for uploading a user video, a site for the user to interact with other users, and a site for viewing travel-related information.

14. The method recited in claim 11, wherein the plurality of modules includes a site for posting user-created material, and further comprising the steps of:
receiving a user selection to register in the site for posting user-created material;
incrementing the user account with a reward unit following the user registration in the site for posting user-created material;
receiving a user selection to create a sub-site for posting user-created material;
incrementing the user account with a reward unit following the user creation of a sub-site;
receiving a user selection to post a comment on a sub-site of another user; and
incrementing the user account with a reward unit following the user posting of a comment of another user sub-site.

15. The method recited in claim 11, wherein the plurality of modules includes a site for the user to send electronic mail, and further comprising the steps of:
receiving a user selection to register in the site for sending electronic mail;
incrementing the user account with a reward unit following the user registration in the site for sending electronic mail;
receiving a user selection to register for an electronic mail newsletter issued by the method;
incrementing the user account with a reward unit following the user registration to receive the electronic mail newsletter;
receiving a user selection to link to an advertisement embedded in one of an electronic mail sent to the user via the electronic mail site and the electronic mail newsletter; and
incrementing a user account with a reward unit following the user linking to an advertisement embedded in the one of the electronic mail and the newsletter.

16. The method recited in claim 11, wherein the plurality of modules includes a site for the user enter an auction, and further comprising the steps of:
receiving a user selection to register in the site for entering an auction;
incrementing the user account with a reward unit following the user registration in the site for entering an auction;
receiving a user selection to upload an item onto the auction site;
incrementing the user account with a reward unit following the user uploading of the item for auction;
receiving a user selection to bid on an item on the auction site;
incrementing the user account with a reward unit following the user bidding on the item on the auction site;
determining if the user wins an auction; and
incrementing the user account with a reward unit following the user winning the auction.
